(19) United States
(12) Patent Application Publication
(10) Pub. No.: US 2026/0350237 A1
(43) Pub. Date: Nov. 5, 2026

(54) METHOD AND APPARATUS FOR PROCESSING DATA ASSOCIATED WITH A HARDWARE SECURITY MODULE

(71) Applicant: Robert Bosch GmbH, Stuttgart (DE)

(72) Inventors: Frederic Stumpf, Leonberg (DE); Aparna Vijaya Krishnan, Tamm (DE); Daniel Hoettges, Sprockhoevel (DE); Hakan Aktas, Asperg (DE); Jens Schmuelling, Ludwigsburg (DE); Martin Assel, Markgroeningen (DE); Peter Poinstingl, Purgstall/Erlauf (AT)

(21) Appl. No.: 19/100,090

(22) PCT Filed: Jul. 21, 2023
(86) PCT No.: PCT/EP2023/070336

§ 371 Date: Mar. 10, 2025

(30) Foreign Application Priority Data
Aug. 1, 2022 (DE) 10 2022 207 910.8

(51) Int. Cl. G06F 21/78

(52) U.S. Cl. CPC G06F 21/78

(57) ABSTRACT

A method for processing data associated with a hardware security module. The method includes: determining first information which characterizes an identity of at least one partition of a computing device that is designed to access the hardware security module, for example accesses the hardware security module, and optionally using the first information, for example to control operation of the hardware security module on the basis of at least the first infrmation.

### FIELD

The present invention relates to a method for processing data associated with a hardware security module.

The present invention furthermore relates to an apparatus for processing data associated with a hardware security module.

### SUMMARY

Exemplary embodiments of the present invention relate to a method for processing data associated with a hardware security module, comprising: determining first information, which characterizes an identity of at least one partition of a computing device that is designed to access the hardware security module, for example accesses the hardware security module, and optionally using the first information, for example to control operation of the hardware security module on the basis of at least the first information. In further exemplary embodiments, this can ensure, for example, that different partitions of the computing device or computer programs associated with the different partitions, such as application programs, do not manipulate data of other partitions that can be processed by the hardware security module.

In further exemplary embodiments of the present invention, the hardware security module is designed to execute cryptographic primitives and/or functions, such as encrypting and/or decrypting and/or forming hash values and/or forming message authentication codes, etc.

In further exemplary embodiments of the present invention, the hardware security module comprises a key store for storing cryptographic keys. For example, on the basis of the first information, it is possible to control which of multiple partitions that can use the functions of the hardware security module are allowed to use particular cryptographic keys. For example, in further exemplary embodiments, it can be provided that some partitions are only allowed to use particular cryptographic keys, while other partitions are allowed to use, for example, all cryptographic keys, etc.

In further exemplary embodiments of the present invention, the at least one partition comprises at least one computing core and, optionally, a memory allocated to the computing core, for example working memory, for example RAM (random access memory). In further exemplary embodiments of the present invention, determining the first information comprises at least one of the following elements: a) determining the first information on the basis of a communication channel that is associated, for example statically, for example exclusively, with the at least one partition, b) receiving the first information via a communication channel that is at least temporarily usable by the at least one partition, wherein, for example, the communication channel is usable by multiple partitions, for example in time-division multiplexing.

In other words, in further exemplary embodiments of the present invention, it can be provided that the first information is provided implicitly, for example by allocating, for example statically, a particular communication channel to a particular partition. In other words, in further exemplary embodiments, the hardware security module can derive an identity of a particular partition on the basis of the (e.g., statically allocated) communication channel (e. g., of a plurality of communication channels) via which information, for example data, was received from the partition.

In further exemplary embodiments of the present invention, the first information and/or further information characterizing the first information, for example together with data for operating the hardware security module, can be transmitted, for example directly, from a partition via a usable communication channel, for example usable jointly with other partitions.

In further exemplary embodiments of the present invention, it is provided that the method comprises: receiving second information, for example an interrupt request, and/or associated with an interrupt request, from the at least one partition; determining the first information on the basis of a communication channel via which the second information was received.

In further exemplary embodiments of the present invention, it is provided that the method comprises at least one of the following elements: a) using a plurality of communication channels for communication with different partitions of the computing device (i.e., for example, for communication of the hardware security module with the different partitions of the computing device), for example using a first communication channel of the plurality of communication channels, for example exclusively, for communication with a first partition and using a second communication channel of the plurality of communication channels, for example exclusively, for communication with a second partition, b) using a, for example common, communication channel for communication with different partitions of the computing device, for example on the basis of a time-division multiplexing method.

In further exemplary embodiments of the present invention, it is provided that the method comprises at least one of the following elements: a) using a first memory area, for example comprising a number of memory registers, to implement a first communication channel, b) using a second memory area, for example comprising a number of memory registers, to implement a second communication channel, c) using a third memory area, for example comprising a number of memory registers, to implement a common communication channel for communication with different partitions of the computing device.

In further exemplary embodiments of the present invention, it is provided that the method comprises at least one of the following elements: a) using a shared memory area, for example a working memory, for example RAM, for example to exchange information, for example data, with the at least one partition, b) virtualizing the shared memory area, for example comprising allocating different sub-areas to, in each case, a different partition of the computing device, c) using a memory protection unit, for example a dynamic memory protection unit, D-MPU, for example for, for example dynamically, protecting at least some memory areas from access by at least some partitions of the computing device.

In further exemplary embodiments of the present invention, it is provided that the method comprises: configuring a or the memory protection unit, for example dynamic memory protection unit, D-MPU, wherein, for example, the configuration is carried out such that the memory protection unit protects at least one memory area, which is, for example, associated with a first partition, from manipulation by at least one other partition.

In further exemplary embodiments of the present invention, it is provided that the method comprises: allocating a priority to the at least one partition; executing an operation associated with the at least one partition, on the basis of at least the priority of the at least one partition.

Further exemplary embodiments of the present invention relate to a device for performing the method according to the embodiments. The apparatus can be implemented, for example, by means of hardware, and at least in some exemplary embodiments can be integrated into or in a hardware security module that is, for example, otherwise at least substantially conventional.

Further exemplary embodiments of the present invention relate to a hardware security module comprising at least one apparatus according to the embodiments.

Further exemplary embodiments of the present invention relate to a computing device, for example a microcontroller or microprocessor or system on a chip, SoC, comprising at least one of the following elements: a) apparatus according to the embodiments, b) hardware security module according to the embodiments, c) at least one partition, for example comprising at least one computing core, and, optionally, memory allocated to the partition, for example working memory, for example RAM.

Further exemplary embodiments of the present invention relate to a method for transmitting data associated with a hardware security module, comprising: providing an identity for at least one partition of a computing device that is designed to access the hardware security module, for example accesses the hardware security module; transmitting information characterizing the identity to the hardware security module, for example via a communication channel, for example common to multiple partitions.

In further exemplary embodiments of the present invention, it is provided that the provision and/or transmission is carried out, for example entirely, in a hardware-based manner.

Further exemplary embodiments of the present invention relate to a method for transmitting data associated with a hardware security module, comprising: providing a first communication channel for exchanging information between a, for example exactly one, first partition of a computing device and the hardware security module; and, optionally, using the first communication channel for exchanging information between the first partition of the computing device and the hardware security module.

In further exemplary embodiments of the present invention, it is provided that the method comprises: providing a second communication channel for exchanging information between a, for example exactly one, second partition of the computing device and the hardware security module; and, optionally, using the second communication channel for exchanging information between the second partition of the computing device and the hardware security module.

Further exemplary embodiments of the present invention relate to an apparatus for performing the method (e.g., for transmitting the data associated with a hardware security module) according to the embodiments.

Further exemplary embodiments of the present invention relate to a computer-readable storage medium comprising commands that, when executed by a computer, cause said computer to perform the method according to the embodiments.

Further preferred embodiments of the present invention relate to a computer program comprising commands that, when the program is executed by a computer, cause said computer to perform the method according to the embodiments.

Further exemplary embodiments of the present invention relate to a data carrier signal that transmits and/or characterizes the computer program according to the embodiments.

Further exemplary embodiments of the present invention relate to a use of the method according to the embodiments and/or the apparatus according to the embodiments and/or the hardware security module according to the embodiments and/or the computing device according to the embodiments and/or the computer-readable storage medium according to the embodiments and/or the computer program according to the embodiments and/or the data carrier signal according to the embodiments for at least one of the following elements: a) determining first information, which characterizes an identity of at least one partition of a computing device that is designed to access the hardware security module, for example accesses the hardware security module, b) virtualizing a hardware security module, c) determining an identity of a partition that accesses the hardware security module, d) prioritizing operations associated with different partitions of a computing device, on the basis of an identity of at least one of the different partitions, e) increasing a security of a hardware security module that can be accessed by multiple partitions of a computing device.

Further features, possible applications and advantages of the present invention will be apparent from the following description of exemplary embodiments of the present invention shown in the figures. In this case, all of the features described or shown form the subject matter of the present invention individually or in any combination, irrespective of their combination or their wording or representation in the description or in the figures.

### BRIEF DESCRIPTION OF THE DRAWINGS

FIG. 1 schematically shows a simplified block diagram according to exemplary embodiments of the present invention.

FIG. 2 schematically shows a simplified flow diagram according to exemplary embodiments of the present invention.

FIG. 3 schematically shows a simplified flow diagram according to exemplary embodiments of the present invention.

FIG. 4 schematically shows a simplified block diagram according to exemplary embodiments of the present invention.

FIG. 5 schematically shows a simplified flow diagram according to exemplary embodiments of the present invention.

FIG. 6 schematically shows a simplified flow diagram according to exemplary embodiments of the present invention.

FIG. 7 schematically shows a simplified flow diagram according to exemplary embodiments of the present invention.

FIG. 8 schematically shows a simplified flow diagram according to exemplary embodiments of the present invention.

FIG. 9 schematically shows a simplified flow diagram according to exemplary embodiments of the present invention.

FIG. 10 schematically shows a simplified flow diagram according to exemplary embodiments of the present invention.

FIG. 11 schematically shows a simplified flow diagram according to exemplary embodiments of the present invention.

FIG. 12 schematically shows a simplified flow diagram according to exemplary embodiments of the present invention.

FIG. 13 schematically shows a simplified flow diagram according to exemplary embodiments of the present invention.

FIG. 14 schematically shows a simplified block diagram according to exemplary embodiments of the present invention.

FIG. 15 schematically shows a simplified time diagram according to exemplary embodiments of the present invention.

FIG. 16 schematically shows a simplified table according to exemplary embodiments of the present invention.

FIG. 17 schematically shows a simplified table according to exemplary embodiments of the present invention.

FIG. 18 schematically shows a simplified block diagram according to exemplary embodiments of the present invention.

FIG. 19 schematically shows a simplified block diagram according to exemplary embodiments of the present invention.

FIG. 20 schematically shows aspects of uses according to further exemplary embodiments of the present invention.

FIG. 21 schematically shows a simplified block diagram according to exemplary embodiments of the present invention.

### DETAILED DESCRIPTION OF EXAMPLE EMBODIMENTS

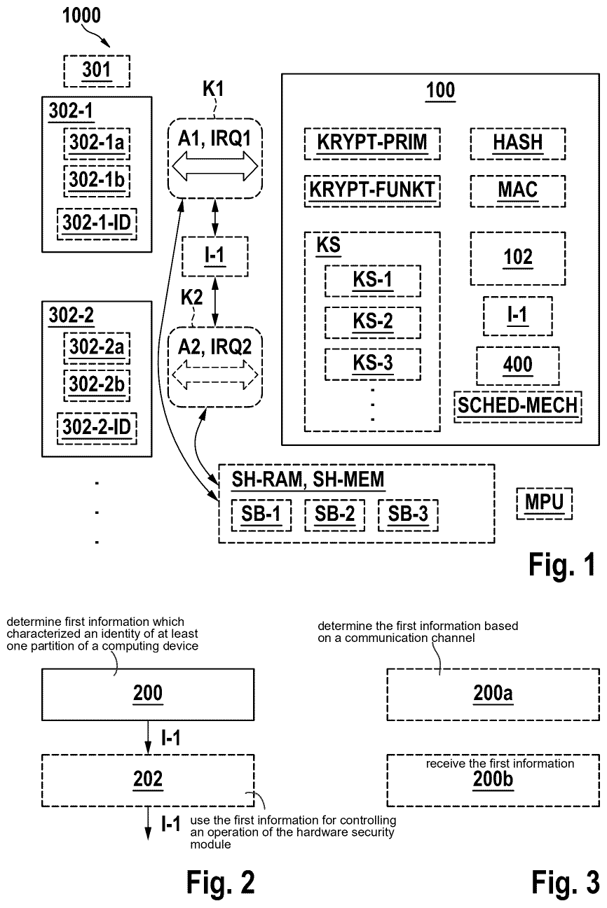

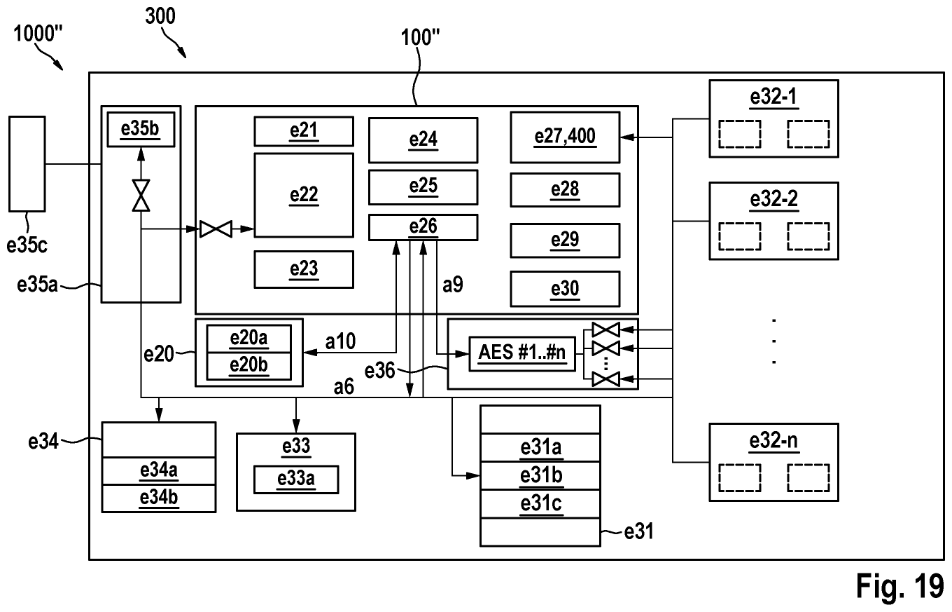

Exemplary embodiments, cf. FIGS. 1, 2, relate to a method for processing data associated with a hardware security module 100, comprising: determining 200 (FIG. 2) first information I-1, which characterizes an identity 302-1-ID (FIG. 1) of at least one partition 302-1 of a computing device 1000 (see, for example, also the elements 300, 1000″ according to FIG. 19) that is designed to access the hardware security module 100, for example accesses the hardware security module 100; and, optionally, using 202 (FIG. 2) the first information I-1, for example for controlling an operation of the hardware security module 100 (FIG. 1) on the basis of at least the first information I-1. In further exemplary embodiments, this can ensure, for example, that different partitions 302-1, 302-2, . . . (FIG. 1) of the computing device 300, 1000, 1000″ or computer programs associated with the different partitions 302-1, 302-2, . . . , such as application programs, do not manipulate data, for example of other partitions, that can be processed by the hardware security module 100.

In further exemplary embodiments, FIG. 1, the hardware security module 100 is designed to execute cryptographic primitives KRYPT-PRIM and/or functions KRYPT-FUNKT, such as encrypting and/or decrypting and/or forming hash values HASH and/or forming message authentication codes MAC, etc.

In further exemplary embodiments, the hardware security module 100 comprises a key store KS for storing cryptographic keys KS-1, KS-2, KS-3, . . . . For example, on the basis of the first information I-1, it is possible to control which of multiple partitions 302-1, 302-2, . . . , of the computing device 1000 can use the resources, for example the cryptographic primitives KRYPT-PRIM and/or the cryptographic functions KRYPT-FUNKT and/or the cryptographic keys KS-1, KS-2, KS-3, . . . of the hardware security module 100. For example, in further exemplary embodiments, it can be provided that some partitions 302-1 are only allowed to use particular cryptographic keys KS-1, while other partitions 302-2 are allowed to use, for example all cryptographic keys KS-1, KS-2, KS-3, etc.

In further exemplary embodiments, the hardware security module 100 comprises at least one, for example secure, computing core 102, which can be separated, for example structurally and/or functionally, from components external to the hardware security module 100, such as the partitions 302-1, 302-2, . . . , and which in further exemplary embodiments is designed, for example, to execute at least some of the cryptographic primitives KRYPT-PRIM or functions KRYPT-FUNKT.

In further exemplary embodiments, FIG. 1, the at least one partition 302-1 comprises at least one computing core 302-1a and, optionally, a memory allocated to the computing core 302-1a, for example working memory, for example RAM (random access memory) 302-1b.

In the present case, for example, the first partition 302-1 comprises a computing core 302-1a and a local working memory 302-1b, i.e., for example a working memory allocated, for example only, to the computing core 302-1a. An identity of the first partition 302-1 is symbolized in FIG. 1 by reference sign 302-1-ID. In further exemplary embodiments, the identity of the first partition 302-1 can correspond to a CPU ID (central processing unit identifier) of the computing core 302-1a or can be based on the CPU ID of the computing core 302-1a.

In a comparable manner, for example, a second partition 302-2 comprises a computing core 302-2a and a local working memory 302-2b, i.e., for example a working memory allocated, for example only, to the computing core 302-2a. An identity of the second partition 302-2 is symbolized in FIG. 1 by reference sign 302-2-ID. In further exemplary embodiments, the identity of the second partition 302-2 can correspond to a CPU ID of the computing core 302-2a or can be based on the CPU ID of the computing core 302-2a.

In further exemplary embodiments, FIG. 1, more than the two partitions 302-1, 302-2 shown by way of example in FIG. 1 can be provided, which is symbolized in FIG. 1 by the three vertically arranged dots at the bottom left in FIG. 1.

In further exemplary embodiments, FIG. 1, the hardware security module 100 can be arranged together with the partitions 302-1, 302-2, . . . , for example on a common semiconductor substrate (not shown in FIG. 1) and/or can form a system on a chip, SoC, 1000, for example with the partitions 302-1, 302-2, . . . and/or with further components not shown for reasons of clarity.

In further exemplary embodiments, FIG. 1, a first communication channel K1 is provided, via which the first partition 302-1, for example only the first partition 302-1 (i.e., for example none of the other partitions 302-2, . . . ), can exchange information, for example data, with the hardware security module 100, cf. block arrow A1.

In further exemplary embodiments, FIG. 1, a second communication channel K2 is provided, via which the second partition 302-2, for example only the second partition 302-2 (i.e., for example none of the other partitions 302-1, . . . ), can exchange information, for example data, with the hardware security module 100, cf. block arrow A2.

In further exemplary embodiments, FIG. 1, individual communication channels comparable to the communication channels K1, K2 can also be provided for at least some of the, for example optionally present, other partitions (not shown).

In further exemplary embodiments, FIG. 1, it is thus provided that each partition 302-1, 302-2, . . . uses its own or individual communication channel K1, K2, . . . to exchange information, for example data, with the hardware security module 100.

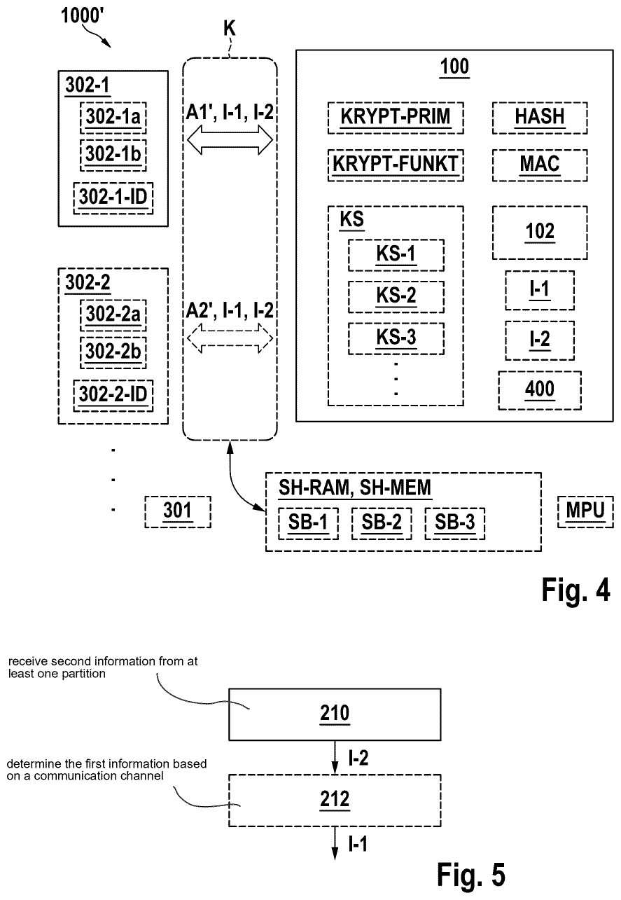

In contrast, FIG. 4 shows a simplified block diagram of a SoC 1000′ according to further exemplary embodiments, in which, instead of a plurality of individual communication channels K1, K2, . . . (FIG. 1), a, for example single, communication channel K is provided, which is usable jointly by multiple partitions 302-1, 302-2, . . . , for example in a time-division multiplex operation, cf. block arrows A1′, A2′.

In further exemplary embodiments, mixed forms (not shown) of the exemplary configuration 1000 according to FIG. 1 and the exemplary configuration 1000′ according to FIG. 4 are also possible, in which, for example, a first number of (e.g., one or more) partitions each have an individual communication channel (see, for example, the elements K1, K2 according to FIG. 1) for exchanging information with the hardware security module 100, and in which, for example, a second number of (e.g., one or more) partitions jointly have a communication channel (see, for example, element K according to FIG. 4) for exchanging information with the hardware security module 100.

In further exemplary embodiments (not shown), further mixed forms are also possible, in which at least one partition 302-1 has an individual communication channel K1 to the hardware security module 100 and is also designed to use a common communication channel K to the hardware security module 100, for example with one or more other partitions 302-2, . . .

In further exemplary embodiments, FIG. 3, determining 200 (FIG. 2) the first information I-1 comprises at least one of the following elements: a) determining 200a (FIG. 3) the first information I-1 on the basis of a communication channel K1 (FIG. 1) that is associated, for example statically, for example exclusively, with the at least one partition 302-1 (see, for example, configuration 1000 according to FIG. 1), b) receiving 200b the first information I-1 via a communication channel K (FIG. 4) that is at least temporarily usable by the at least one partition 302-1, wherein, for example, the communication channel K is usable by multiple partitions 302-1, 302-2, . . . , for example in time division multiplexing (see, for example, configuration 1000′ according to FIG. 4).

In other words, in further exemplary embodiments, see FIG. 1, it can be provided that the first information I-1 is provided implicitly, for example by allocating, for example statically, a particular communication channel K1 to a particular partition 302-1. In other words, in further exemplary embodiments, the hardware security module 100 can derive an identity 302-1-ID of a particular partition 302-1 on the basis of the (e.g., statically allocated) communication channel K1 (e.g., of a plurality of communication channels K1, K2, . . . ) via which information, for example data, A1 was received from the partition 302-1.

In further exemplary embodiments, FIG. 4, the first information I-1 and/or further information characterizing the first information I-1, for example together with data for operating the hardware security module, can be transmitted, for example directly, from a partition 302-1 via a usable communication channel K, for example usable jointly with other partitions 302-2, . . . , see, for example, reference signs I-1 at block arrows A1′, A2′ in FIG. 4.

In further exemplary embodiments, FIG. 1, the first information I-1 and/or further information characterizing the first information I-1, for example together with data for operating the hardware security module 100, can be transmitted, for example directly, from a partition 302-1 via a, for example individual, communication channel K1 to the hardware security module 100. In further exemplary embodiments, this is not necessary, for example, due to the exemplary static, for example 1-to-1, allocation of partitions 302-1, 302-2 to communication channels K1, K2 according to FIG. 1, so that the hardware security module 100 obtains the first information I-1, for example determines or can determine an identity of a partition that accesses the hardware security module 100. Nevertheless, the separate transmission of, for example, the first information I-1, for example via a partition-specific communication channel K1, is not excluded in further exemplary embodiments.

In further exemplary embodiments, FIG. 5, it is provided that the method comprises: receiving 210 second information I-2, for example an interrupt request IRQ1, IRQ2 and/or associated with an interrupt request, i.e., information associated with an interrupt request, from the at least one partition 302-1, 302-2, (FIG. 1); determining 212 (FIG. 5) the first information I-1 on the basis of a communication channel K1, K2, . . . via which the second information I-2 was received. For example, if the hardware security module 100 receives a first interrupt request IRQ1, for example via the first communication channel K1 according to FIG. 1, it can conclude that the first interrupt request IRQ1 or data associated with the first interrupt request IRQ1 come from the first partition 302-1 because the first communication channel K1 is allocated, for example statically, to the first partition 302-1. In contrast, in further exemplary embodiments, if the hardware security module 100 receives a second interrupt request IRQ2, for example via the second communication channel K2 according to FIG. 1, it can conclude that the second interrupt request IRQ2 or data associated with the second interrupt request IRQ2 come from the second partition 302-2 because the second communication channel K2 is allocated, for example statically, to the second partition 302-2, etc.

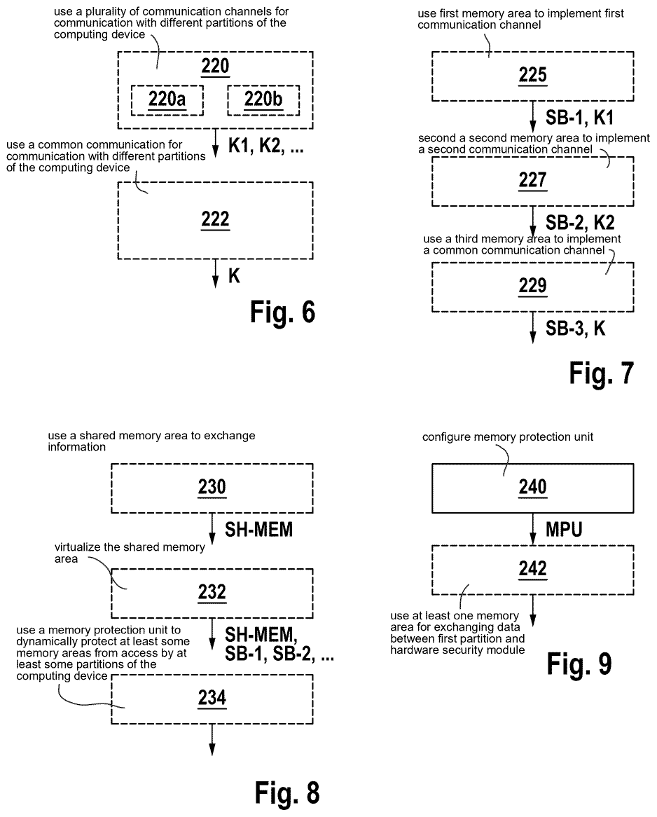

In further exemplary embodiments, FIG. 6, it is provided that the method comprises at least one of the following elements: a) using 220 a plurality of communication channels K1, K2, . . . (FIG. 1) for communication with different partitions 302-1, 302-2, . . . (FIG. 1) of the computing device 1000 (i.e., for example, for communication of the hardware security module 100 according to FIG. 1 with the different partitions 302-1, 302-2, . . . of the computing device 1000), for example using 220a (FIG. 6) a first communication channel K1 of the plurality of communication channels K1, K2, . . . , for example exclusively, for communication A1 with the first partition 302-1 and using 220b (FIG. 6) a second communication channel K2 of the plurality of communication channels K1, K2, . . . , for example exclusively, for communication A2 with the second partition 302-2, b) using 222 (FIG. 6) a, for example common, communication channel K (FIG. 4) for communication A1′, A2′ with different partitions 301-1, 301-2, . . . of the computing device, for example on the basis of a time-division multiplexing method.

In further exemplary embodiments, FIG. 7, it is provided that the method comprises at least one of the following elements: a) using 225 a first memory area SB-1 (FIG. 1), for example comprising a number of memory registers (not shown), to implement a first communication channel K1, b) using 227 (FIG. 7) a second memory area SB-2 (FIG. 1), for example comprising a number of memory registers, to implement a second communication channel K2, c) using 229 (FIG. 7) a third memory area SB-3, for example comprising a number of memory registers, to implement a common communication channel K (FIG. 4) for communication with different partitions 302-1, 302-2, . . . of the computing device 1000, 1000′.

In further exemplary embodiments, at least one of the memory areas SB-1, SB-2, SB-3 can be provided in a shared memory (i.e., for example a memory usable by one or more partitions and the hardware security module 100), for example working memory, RAM, SH-RAM.

In further exemplary embodiments, FIG. 8, it is provided that the method comprises at least one of the following elements: a) using 230 a shared memory area SH-MEM, for example a working memory, for example RAM, SH-RAM, for example to exchange information, for example data, with the at least one partition 302-1, 302-2, . . . , b) virtualizing 232 the shared memory area SH-MEM, for example comprising allocating different sub-areas, for example the memory areas SB-1, SB-2, of the shared memory area SH-MEM to, in each case, a different partition 302-1, 302-2 of the computing device, c) using 234 (FIG. 8) an optional memory protection unit MPU (FIGS. 1, 4), for example a dynamic memory protection unit, D-MPU, for example for, for example dynamically, protecting at least some memory areas SB-1 from access by at least some partitions 302-2 of the computing device. In further exemplary embodiments, FIG. 9, it is provided that the method comprises: configuring 240 a or the memory protection unit MPU, for example dynamic memory protection unit, D-MPU, wherein, for example, the configuration 240 is carried out such that the memory protection unit MPU protects at least one memory area SB-1 (FIGS. 1, 4), which is, for example, associated with a or the first partition 302-1, from manipulation by at least one other partition 302-2, . . . . The optional block 242 according to FIG. 9 symbolizes a use of the at least one memory area SB-1 for exchanging data between the first partition 302-1 and the hardware security module 100.

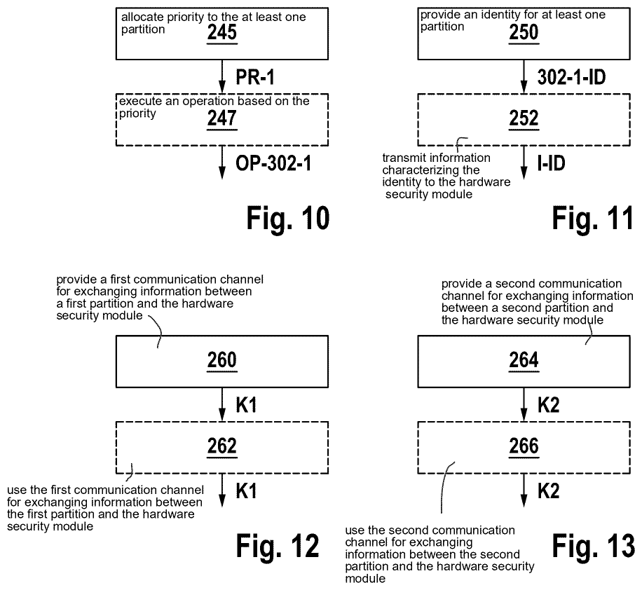

In further exemplary embodiments, FIG. 10, it is provided that the method comprises: allocating 245 a priority PR-1 to the at least one partition 302-1; executing 247 an operation OP-302-1 associated with the at least one partition 302-1 (e. g., encrypting data) on the basis of at least the priority PR-1 of the at least one partition 302-1. In further exemplary embodiments, the priority PR-1 can, for example, be allocated on the basis of the first information I-1. Further exemplary aspects and embodiments relating to a priority are described below, for example with reference to FIG. 15.

Further exemplary embodiments, cf. FIG. 21, relate to an apparatus 400 for performing the method according to the embodiments. The apparatus 400 can be implemented, for example by means of hardware, for example exclusively by means of hardware, and at least in some exemplary embodiments can be integrated into or in a hardware security module 100, see, for example, FIGS. 1, 4.

Further exemplary embodiments, FIGS. 1, 4, relate to a hardware security module 100 comprising at least one apparatus 400 according to the embodiments.

In further exemplary embodiments, FIG. 21, it is provided that the apparatus 400 comprises: a computing device (computer) 402, for example comprising at least one computing core 402a; a memory device 404 allocated to the computing device 402 for at least temporarily storing at least one of the following elements: a) data DAT (e.g., characterizing at least one of the following elements: the first information I-1, the second information I-2, information characterizing an identity 302-1-ID of at least one partition 302-1, information characterizing an allocation of communication channels K1, K2 to partitions 302-1, 302-2, information characterizing a priority PR-1 associated with at least one partition 302-1, configuration information, for example for a virtualization 232 of the shared memory area SH-MEM and/or for a or the memory protection unit MPU), b) computer program PRG, in particular for performing the method according to the embodiments (e.g., in the case of a non-purely hardware-based implementation of the apparatus 400).

In further exemplary embodiments, the memory device 404 has a volatile memory 404a (e.g., working memory (RAM) ) and/or a non-volatile memory 404b (e.g., flash EEPROM) or a combination thereof or with other memory types not explicitly mentioned.

Further exemplary embodiments relate to a computer-readable storage medium SM, for example semiconductor memory and/or optical data carriers and/or magnetic storage medium, comprising commands PRG that, when executed by a computer 402, cause said computer to perform the method according to the embodiments.

Further preferred exemplary embodiments relate to a computer program PRG comprising commands that, when the program PRG is executed by a computer 402, cause said computer to perform the method according to the embodiments.

Further exemplary embodiments relate to a data carrier signal DCS that transmits and/or characterizes the computer program PRG according to the embodiments. The data carrier signal DCS can be transmitted, for example, via an optional data interface 406, for example in the same way as other optional data D.

In further exemplary embodiments, for example when integrating the apparatus 400 or a functionality of the apparatus 400 into the hardware security module 100, at least some of the components 402, 402a, 404, 404a, 404b, . . . of the apparatus 400 according to FIG. 21 can be realized or implemented, for example using corresponding and possibly already existing components of the hardware security module 100 (e.g., the computing core 402a according to FIG. 21 by the HSM computing core 102, etc.).

Further exemplary embodiments, FIGS. 1, 4, relate to a computing device, for example a microcontroller or microprocessor or system on chip, SoC, 1000, 1000′, comprising at least one of the following elements: a) apparatus 400 according to the embodiments, b) hardware security module 100, for example according to the embodiments, c) at least one partition 302-1, 302-2, . . . , for example comprising at least one computing core 302-1a, 302-2a, . . . , and, optionally, memory allocated to the partition, for example working memory, for example RAM 302-1b, 302-2b, . . . .

Further exemplary embodiments, FIG. 11, relate to a method for transmitting data associated with a hardware security module 100 (FIGS. 1, 4), comprising: providing 250 an identity 302-1-ID for at least one partition 302-1 of a computing device that is designed to access A1 the hardware security module 100, for example accesses the hardware security module 100; transmitting 252 information I-ID characterizing the identity 302-1-ID (e. g., in the form of the second information I-2 and/or the first information I-1 and/or the identity 302-1-ID itself) to the hardware security module 100, for example via a communication channel K (FIG. 4), for example common to multiple partitions.

In further exemplary embodiments, FIG. 11, it is provided that the provision 250 and/or transmission 252 is carried out, for example entirely, in a hardware-based manner.

Further exemplary embodiments, FIG. 12, relate to a method for transmitting data associated with a hardware security module 100 (FIGS. 1, 4), comprising: providing 260 (FIG. 12) a first communication channel K1 (FIG. 1) for exchanging information A1 between a, for example exactly one, first partition 302-1 of a computing device and the hardware security module 100; and, optionally, using 262 the first communication channel K1 for exchanging information A1 between the first partition 302-1 of the computing device and the hardware security module 100.

In further exemplary embodiments, FIG. 13, it is provided that the method comprises: providing 264 a second communication channel K2 (FIG. 1) for exchanging information A2 between a, for example exactly one, second partition 302-2 of the computing device and the hardware security module 100; and, optionally, using 266 the second communication channel K2 for exchanging information A2 between the second partition 302-2 of the computing device and the hardware security module 100.

Further exemplary embodiments, FIG. 1, relate to an apparatus 301 for performing the method, for example for transmitting the data associated with a hardware security module, according to the embodiments, for example according to FIG. 11 and/or FIG. 12 and/or FIG. 13.

In further exemplary embodiments, the apparatus 301 (FIG. 1) has, for example, a configuration comparable or at least similar to the apparatus 400 according to FIG. 21, wherein a, for example purely hardware-based, implementation is possible.

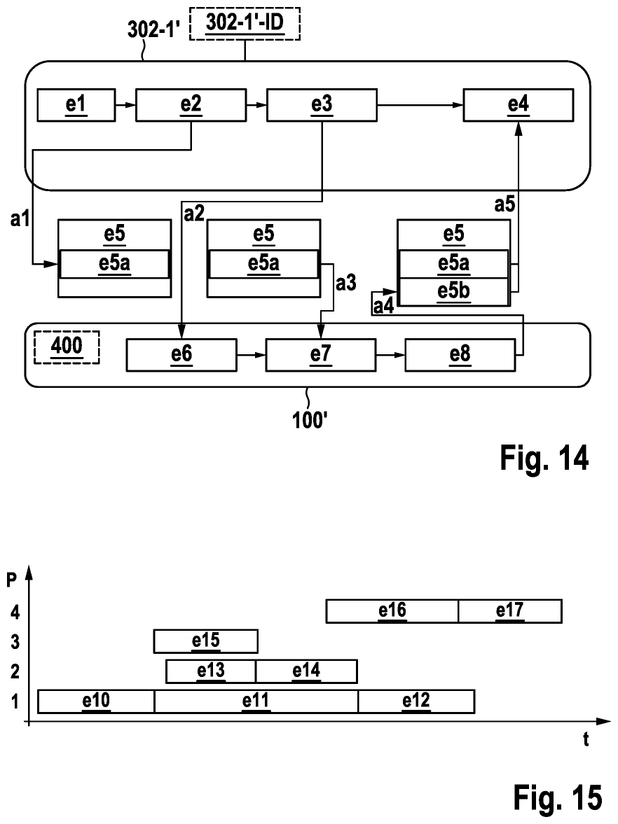

FIG. 14 schematically shows a simplified block diagram according to exemplary embodiments, illustrating an information flow between a partition 302-1′ of a computing device and a hardware security module 100′ according to further exemplary embodiments. Element e1 symbolizes an application or an application program that can be executed on the partition 302-1′ and that executes, for example, security-related functions and uses the hardware security module 100′ at least temporarily for this purpose. Element e2 symbolizes a preparation of data for processing by means of the hardware security module 100′, for example a security job. Arrow a1 symbolizes the writing of the prepared data into a memory area e5a of a memory e5, for example shared with the hardware security module 100′, for example shared RAM. Element e3 symbolizes signaling to the hardware security module 100′, for example that the security job is ready for processing by the hardware security module 100′, see also arrow a2. Signaling e3 can be carried out, for example, using an interrupt request that the partition 302-1′ sends to the hardware security module 100′. In addition to, for example together with, the interrupt request, the hardware security module 100′ can, for example, also be transmitted information characterizing the memory area e5a, for example in the form of a pointer to a corresponding address of the shared memory e5, and/or information characterizing for example a cryptographic key KS-1 (FIG. 1) stored in the hardware security module 100′, for example in the form of a pointer to a corresponding address of the key store KS.

Element e6 symbolizes receiving or reading the information or data signaled by the partition 302-1′, see also arrow a3. Element e7 symbolizes processing of the data by the hardware security module 100′. Element e8 symbolizes an output of a result of the data processing by the hardware security module 100′, for example into the memory area e5b of the shared memory e5, see also arrow a4. Element e4 symbolizes reading of the result of the data processing of the hardware security module 100′ by the partition 302-1′, see also arrow a5.

In further exemplary embodiments, for example in the case of at least one or some or all interrupt requests a2 that the partition 302-1′ sends to the hardware security module 100′, for example in addition to an interrupt request number or interrupt number characterizing the interrupt request, information about the identity 302-1′-ID of the sending partition 302-1′ can also be transmitted to the hardware security module 100′.

In further exemplary embodiments, the identity 302-1′-ID is provided, for example via a hardware-based, for example purely hardware-based, mechanism so that manipulation, for example by software, for example the application e1, is not possible.

In further exemplary embodiments, it is provided that the identity 302-1′-ID of the partition 302-1′ is transmitted in at least some, for example multiple, for example each, for example any, interaction of the partition 302-1′, for example with the memory e5 and/or with the hardware security module 100′, for example along with other information (i.e., for example possibly in addition to other information or data).

In further exemplary embodiments, the hardware security module 100′ and the at least one partition 302-1′ are configured such that they can exchange information or data, for example via at least one corresponding address range e5a, e5b, which is located, for example, in the shared memory, for example shared RAM, e5.

In further exemplary embodiments, this address range contains, for example, information that characterizes which operation(s) are to be executed in the hardware security module 100′, as well as, if applicable, a pointer to data that can, for example, be used for the operation(s) (e.g., a pointer to data that are to be encrypted by the hardware security module 100′, as well as, if applicable, further information, for example regarding the operation(s) to be executed (e.g., parameters) ).

In further exemplary embodiments, an apparatus 400 according to the embodiments can be provided in the hardware security module 100′, which apparatus in further exemplary embodiments can also be referred to as a partition detector, for example.

In further exemplary embodiments, the apparatus 400 associates and/or manages, for example for some, for example, all, operations executed or invoked in the hardware security module 100′, a, for example unique, identity, for example partition ID. In further exemplary embodiments, for example all, operations that are executed or invoked in the hardware security module 100′ can thus be traced back to a particular partition, which can be referred to as the “original partition,” for example.

In further exemplary embodiments, a number of partitions and/or associated partition IDs are configured in the system, for example SoC 1000, for example on the basis of a number of physical partitions 302-1, 302-2, . . . (FIG. 1).

In further exemplary embodiments, FIG. 1, for example when an operation of a partition 302-1 is executed in the hardware security module 100, for example by the apparatus 400 and/or under the control of the apparatus 400, it is ensured that, for example, only data associated with this partition 302-1 are or can be accessed. For this purpose, in further exemplary embodiments, at least one function, for example application, of the hardware security module 100, such as the key store KS or a secure data storage (e.g., secure log, not shown), can be virtualized accordingly.

In further exemplary embodiments, FIG. 1, the hardware security module 100, 100′ is designed to carry out sequence planning, for example scheduling, for example preemptive scheduling, of operations.

In further exemplary embodiments, scheduling can be implemented via a software-based or firmware-based mechanism SCHED-MECH FIG. 1, in the hardware security module 100, 100′. In further exemplary embodiments, for example individual operations are each allocated a corresponding priority, and the individual operations are executed on the hardware security module 100 according to the allocated priority. The optional, for example firmware-based mechanism SCHED-MECH according to FIG. 1 can optionally also be provided in the HSM 100 according to FIG. 4 but is not shown there for reasons of clarity.

For example, if an operation with a lower priority is being executed while an operation with a higher priority reaches the hardware security module 100 (e.g., by signaling by a partition), in further exemplary embodiments, the new operation is prioritized and the operation with the lower priority is paused. In further exemplary embodiments, information, for example all information describing the state of the operation, is saved in a memory before pausing, so that the operation with the lower priority can be completed, for example after the execution of the operation with the higher priority.

When using the principle according to the embodiments, for example with the apparatus 400, for example as a partition detector, for example with multiple partitions 302-1, 302-2, . . . (FIG. 1), in further exemplary embodiments, the preemptive scheduling can be designed such that the apparatus 400 and/or the scheduling mechanism SCHED-MECH, for example in the hardware security module 100, is configured such that individual partitions also have corresponding priorities which invalidate the priorities of a specific operation, for example from a certain threshold value. In further exemplary embodiments, this prevents individual operations of individual partitions from “starving,” i.e., not being executed for a comparatively long period of time (or not being executed at all, for example).

In further exemplary embodiments, the above-mentioned threshold value can be defined, for example by means of comparatively complex rules, but comparatively simple rules are also possible in still further exemplary embodiments.

In further exemplary embodiments, the threshold value can, for example, be configured such that an operation of a particular partition with a specific priority level (priority value) can be interrupted, for example only n times, n>=0. A simplified example according to further exemplary embodiments is shown in the diagram according to FIG. 15, in which a horizontal axis t characterizes the time and in which a vertical axis P characterizes a priority. For reasons of clarity, four different priority values 1, 2, 3, 4 are provided here by way of example and it is assumed, by way of example and without limitation of generality, that there are four partitions that can access the hardware security module 100 (FIG. 1). In further exemplary embodiments, there can be fewer or more than four different priority values and/or fewer or more than four partitions.

In further exemplary embodiments, scheduling is provided, for example via a software-based or firmware-based mechanism SCHED-MECH (FIG. 1), in the hardware security module 100, 100′ such that operations of a first partition 302-1 can be interrupted, for example only at most two times. In the present case, by way of example, an operation e10 of the first partition with priority value 1 (lowest priority) is interrupted by an operation e15 of a third partition (priority value 3) and thereafter by an operation e14 of a second partition (priority value 2). Before a fourth operation (priority value 4) is executed e17, for example the first operation is continued, for example completely executed, see element e12. Element e11 symbolizes an interruption of the first operation e10, e12, element e13 symbolizes waiting of an operation of the second partition for completion of the operation e15, and element e16 symbolizes waiting of the operation e17 of the fourth partition for completion of the operation e12.

In further exemplary embodiments, virtualization of a communication channel between partitions 302-1, 302-2, (FIG. 1) of the computing device and the hardware security module 100, 100′ is provided.

In further exemplary embodiments, different methods can be used for signaling which partition of the multiple partitions 302-1, 302-2,. for example currently, wants to initiate communication with the hardware security module 100, 100′. In further exemplary embodiments, for example, multiplication of the communication channel is provided, see, for example, the configuration 1000 according to FIG. 1. In further exemplary embodiments, for example sharing, of the (e.g., single) communication channel K is provided, see, for example, the configuration 1000′ according to FIG. 4.

In further exemplary embodiments, in the aforementioned multiplication of the communication channel, a, for example full, register set (e.g., set of memory registers), which is used for the communication with the hardware security module 100, 100′, is provided, for example to each individual partition 302-1, 302-2, . . . , see channel K1 for the first partition 302-1, channel K2 for the second partition 302-2, etc. This means that, in further exemplary embodiments, each partition 302-1, 302-2, . . . is physically uniquely provided with a complete register set.

In further exemplary embodiments, the register sets are numbered, for example consecutively, so that the apparatus 400, for example the partition detector, in the hardware security module 100, 100′ can clearly determine, for example validate, from which partition a corresponding communication came. In further exemplary embodiments, an advantage of this variant is that there can be no collisions in the communication channel (or the plurality of channels K1, K2, . . . ) between the individual partitions 302-1, 302-2, . . . .

In further exemplary embodiments, in the above-mentioned sharing, a (e.g., common) communication channel K (FIG. 4) is shared between the individual partitions 302-1, 302-2, . . . , in this case, for example all, partitions are provided with unique identities (e.g., partition ID), which in further exemplary embodiments are derived, for example on the basis of a CPU ID of their corresponding computing core.

In further exemplary embodiments, it can be provided that the partition ID is represented, for example via a byte value (i.e., an amount of information comprising 8 bits), which is, for example, unique. In further exemplary embodiments, for example in the event of an interrupt of a particular partition, its unique partition ID is transmitted in the communication channel K to the hardware security module, for example in addition to any other information or data to be transmitted. If the communication channel K is currently occupied, for example by another partition, it can be provided that the partition waits until the communication channel K is available again for sending another communication (such as an interrupt). In further exemplary embodiments, an advantage of this method can be that a single communication channel K is present, i.e., that the communication channel K does not have to be multiplied, for example.

In further exemplary embodiments, FIG. 1, it is possible to provide virtualization of the shared memory SH-MEM. In further exemplary embodiments, the shared memory SH-MEM can be used, for example, to exchange data between the partitions and the hardware security module 100, 100′. In particular, it can be provided that multiple, for example all, partitions access the shared memory SH-MEM. In this case, in some exemplary embodiments, a situation could arise in which a second partition manipulates the data of the first partition in the shared memory SH-MEM and thus possibly influences the processing of an operation in the hardware security module 100, 100′. This is prevented in further exemplary embodiments, for example, by at least one of the following elements: a) virtualization of the shared memory SH-MEM, for example by means of sharing, b) use of a memory protection unit MPU, for example dynamic MPU.

In further exemplary embodiments, virtualization of the shared memory SH-MEM is executed by means of sharing, wherein the shared memory is configured, for example, such that dedicated areas SB-1, SB-2 in which, for example, only one partition can write in each case and, for example, the other partitions can operate only in a reading manner (or, for example, not at all) are specified, for example, per partition 302-1, 302-2. In further exemplary embodiments, the hardware security module 100, 100′ can be designed, for example configured, such that it can operate in a reading and writing manner on all memory areas that are, for example, configured accordingly, which offers a comparatively high level of reliability in further exemplary embodiments.

In further exemplary embodiments, for example, a dynamic memory protection unit (D-MPU) MPU (FIG. 1) can be used to virtualize individual memory areas, for example memory blocks. In further exemplary embodiments, the D-MPU protects memory and address ranges, for example similarly to an MPU. In further exemplary embodiments, the D-MPU, for example, unlike a conventional MPU or MMU (memory management device), can be configured dynamically, for example on demand (i.e., for example, as needed, and thus flexibly), for example by the hardware security module 100, 100′, for example in response to a request from a software application e1 (FIG. 14), for example so that specifiable address ranges of the memory device are protected accordingly. For example, after a memory area has been appropriately protected by the D-MPU, in further exemplary embodiments, for example only the hardware security module 100, 100′ can still make changes to this memory area. In further exemplary embodiments, this ensures, for example, that a potential attacker who has taken over, for example a software system (e.g., excluding the hardware security module 100, 100′) does not pass manipulated information to the hardware security module 100, 100′ and/or make corresponding changes to the contents in a memory area during data processing by the hardware security module 100, 100′.

In further exemplary embodiments, for example in addition to the use of the D-MPU, information is provided as to which partition owns the particular memory area. In further exemplary embodiments, the use of the D-MPU also, for example, prevents manipulations by one partition in the memory area of another partition.

In further exemplary embodiments, however, for example in contrast to memory sharing, an owning partition is additionally prevented from manipulating its memory area after it has passed the data to the hardware security module 100, 100′, for example for the purpose of an operation on the memory area.

In further exemplary embodiments, the D-MPU is configured dynamically, for example at runtime, for example exclusively, by a or the hardware security module 100, 100′. For this purpose, the D-MPU can protect, for example, individual and/or multiple, address ranges in the memory from changes by the individual partitions.

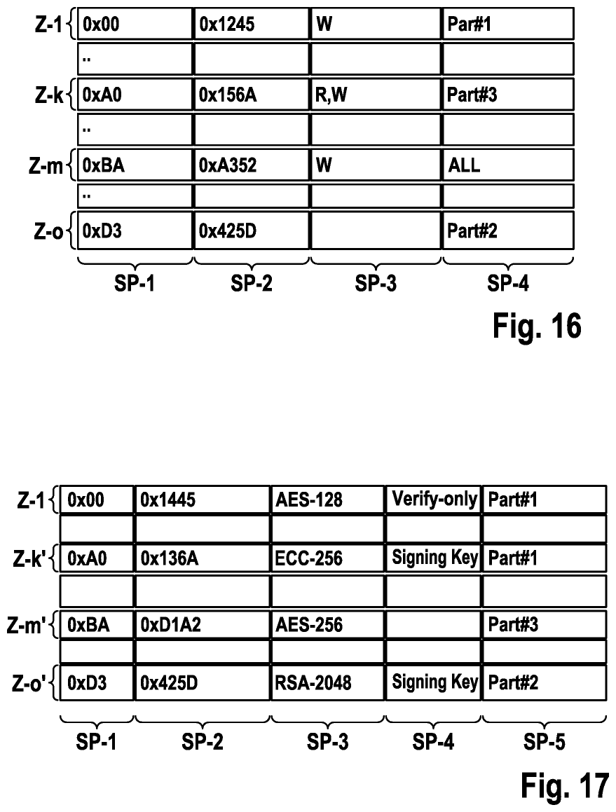

In FIG. 16, a memory area of a memory device according to exemplary embodiments is shown in a simplified manner. A first column SP-1 characterizes a memory address, a second column SP-2 characterizes a data content, a third column SP-3 characterizes at least one protection flag (e.g., characterizable by one or more bits, for example a, for example linear, bitmap), and a fourth column SP-4 characterizes an owner, i.e., for example, a partition that owns the corresponding memory area. As can be seen in FIG. 16, a first row Z-1 describes a memory address 0x00 with the data content 0x1245, a protection flag “W,” and that this memory address is allocated to a first partition Par #1. Another row Z-k describes a memory address 0xA0 with the data content 0x156A, protection flags “R,” “W,” and that this memory address is allocated to a third partition Par #3. Another row Z-m describes a memory address 0xBA with the data content 0xA352, a protection flag “W,” and that this memory address is allocated to all partitions. Another row Z-o describes a memory address 0xD3 with the data content 0x425D, without protection flags, and that this memory address is allocated to a second partition Par #2.

In further exemplary embodiments, the protection flags are defined, for example, as follows:
“W” =write protection, no changes are possible in the address range, read access is possible;
“R,” “W”=read/write protection, neither read nor write access is possible;
“ ”=no protection or flag set, the address range can be accessed both in a reading and writing manner;
“Part #n,” n>=1, describes the partition to which this memory area belongs. For example, in principle, only this partition is allowed to access the memory accordingly (e.g., according to “R,” “W”) unless, for example the protection flags override the access permission;
“ALL” =all partitions can access this memory area in any way.

In further exemplary embodiments, the protection flags of the memory area can change at runtime, for example, due to a corresponding configuration of the D-MPU by the hardware security module 100, 100′. In further exemplary embodiments, it is provided that the hardware security module 100, 100′ protects at least one memory area, for example from further access, for example manipulation, for example by an owner (e.g., partition owner), for example after data have been passed by the partition to the hardware security module 100, 100′, whereby, for example, time-of-check/time-of-use attacks can be prevented in further exemplary embodiments.

In the following, aspects of a key store KS (FIG. 1) according to further exemplary embodiments are described by way of example, for example relating to a virtualization of the key store KS. In the following, aspects of the apparatus 400, for example in the sense of a partition detector, are, for example, also illustrated using the example of the key store KS, wherein, in further exemplary embodiments, the aspects mentioned are, for example, also transmittable to other, for example, all other, application scenarios of the hardware security module 100, 100′ in which, for example sensitive, data belong to a specific partition, such as applications relating to the aspect of secure logging.

In further exemplary embodiments, for example all, cryptographic keys are securely stored in the key store KS. The key store KS is stored in encrypted form, for example in a flash memory, and is loaded into the hardware security module 100, 100′, for example during an initial boot. In order to prevent one partition from accessing cryptographic material of another partition, the corresponding access rights in further exemplary embodiments are configured, for example for each individual entry, in the key store KS.

In further exemplary embodiments, in the key store KS, for example in addition to access rights such as read, write, execute, for example per key entry KS-1, KS-2, KS-3, . . . , corresponding additional protection flags can also be provided, for example set, for example as described above by way of example for a memory device, for example the shared memory SH-MEM. If these protection flags are set accordingly, it would mean, for example, that one partition can overwrite a key, for example, but another partition can only use the key (but, for example, not overwrite it). In further exemplary embodiments, the setting of a read flag for the key store KS can, for example, also be provided.

FIG. 17 schematically shows a simplified table according to exemplary embodiments, containing information of an exemplary key store. A key identification (e.g., key ID) is contained in column SP-1, column SP-2 contains the cryptographic key, column SP-3 contains information about a key type or an algorithm for which the key in question can be used, column SP-4 contains further properties of the key in question (e.g., verify-only, signing key), and column SP-5 indicates a partition as the owner of the key in question, if applicable. In further exemplary embodiments, for example, only the owner of the key according to column SP-5 is allowed to use the cryptographic key in question for operations. Further rights granularities are also possible in further exemplary embodiments but are not shown in the exemplary illustration according to FIG. 17.

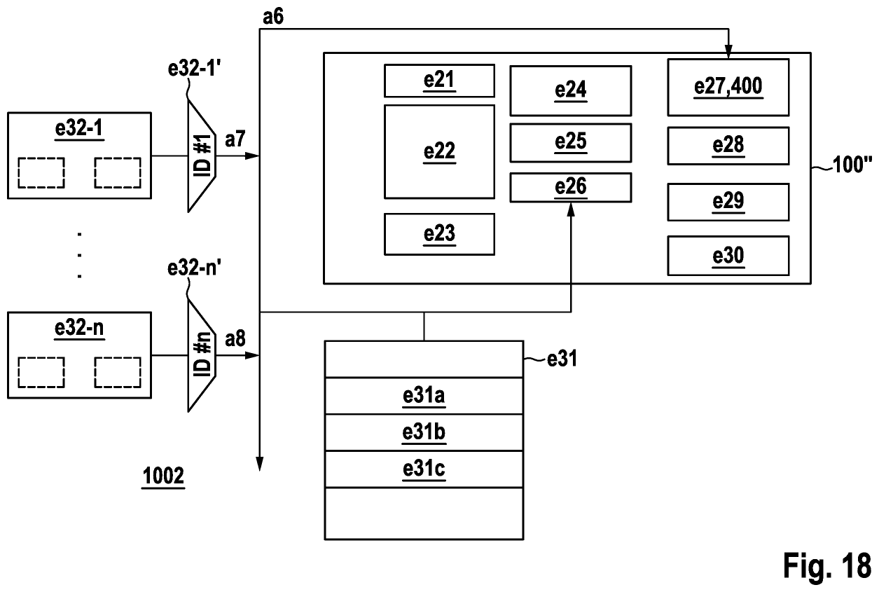

FIG. 18 schematically shows a simplified block diagram according to further exemplary embodiments. Shown is a hardware security module 100″, which is arranged, for example, on the same Semiconductor substrate 1002 as multiple partitions e32-1, . . . , e32-n of a computing device. An exchange of information or data between the components e32-1, . . . , e32-n, 100′′ takes place, for example, via a, for example on-chip, bus system a6. Some, for example all, partitions e32-1, . . . , e32-n are each allocated a unit e32-1′, e32-n′ for providing an identification ID #1, . . . , ID #n of the partition e32-1, . . . , e32-n allocated to it, which, for example, transmits the identification of the corresponding partition to the hardware security module 100″, see arrows a7, a8, for example when the corresponding partition transmits data to the hardware security module 100″. In this way, the hardware security module 100″ obtains first information I-1, which characterizes an identity of at least one partition e32-1, . . . , e32-n that accesses the hardware security module 100″.

Element e21 symbolizes an optional device for supporting debug processes. Element e22 symbolizes a, for example secure, computing core. Element e23 symbolizes at least one entropy source, for example a pseudorandom number generator (PRNG) or a random number generator (TRNG). Element e24 symbolizes a, for example secure, memory (e.g., protected from access outside the hardware security module 100″), for example volatile memory, for example working memory, for example a secure local RAM. Element e25 symbolizes a device for forming hash values. Element e26 symbolizes an interface to the bus system a6. Element e27 symbolizes the apparatus 400 according to the embodiments. Element e28 symbolizes a device for executing cryptographic primitives and/or functions, for example on the basis of ECC (elliptic-curve cryptography). Element e29 symbolizes a device for executing cryptographic primitives and/or functions, for example on the basis of the RSA algorithm. Element e30 symbolizes a device for executing cryptographic primitives and/or functions, for example on the basis of the AES algorithm.

Element e31 symbolizes a memory device, for example connected via the bus system a6, for example of the RAM type, which is divided, for example, into a shared memory area e31a, a system RAM e31b, and a protected area e31c.

The apparatus e27, 400 can determine an identity of individual partitions e32-1, . . . and provide it, for example, for controlling an operation of the hardware security module 100″ on the basis of the determined identity.

FIG. 19 schematically shows a simplified block diagram of a SoC 1000″ according to exemplary embodiments, which comprises a computing device 300 with multiple partitions e32-1, e32-2, . . . , e32-n, a hardware security module 100″, a memory device e31, for example similar or identical to the configuration according to FIG. 18. Element e33 symbolizes a D-MPU with a configuration e33a, which can be specified and/or changed, for example by the hardware security module 100″, for example via the bus system a6. Element e34 symbolizes a non-volatile memory, for example a flash memory, for example host flash, which has, for example, a memory area e34a for data and a memory area e34b for program code. Element e35a symbolizes an on-chip or SoC-internal diagnostic interface, element e35b symbolizes registers associated with the diagnostic interface e35a, and element e35c symbolizes an external diagnostic device (arranged outside the SoC 1000″), for example a debug access port, i.e., a connection for diagnostic access, for example for debugging.

The element e36 symbolizes a device for processing, for example data associated with the AES, which device is connected to the interface e26, for example via a secure bus system a9, for example identically or similarly to the flash memory e20 allocated to the hardware security module 100″, see the secure bus system a10. The flash memory e20 comprises, for example, a data area e20a and an area e20b for program code.

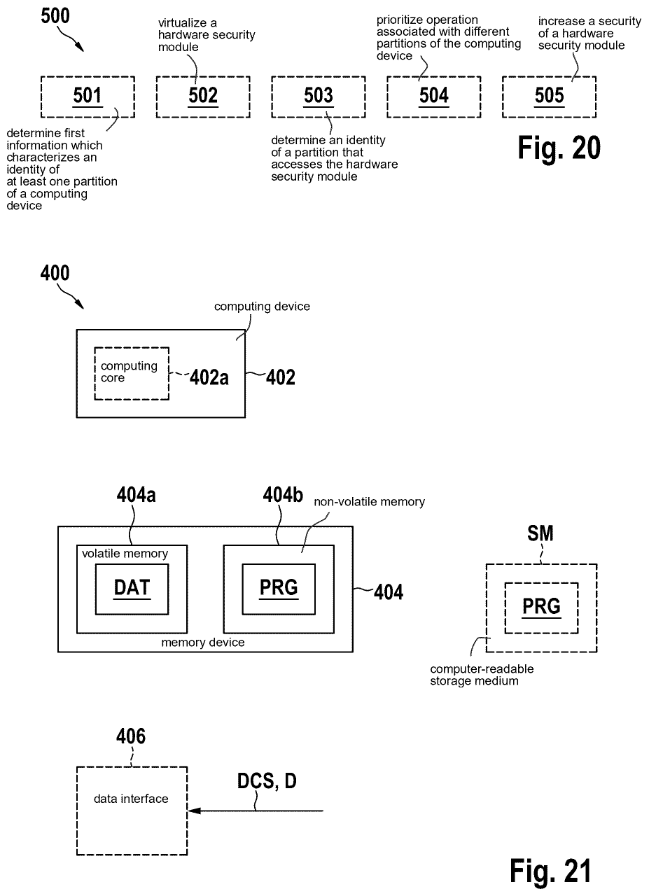

Further exemplary embodiments, FIG. 20, relate to a use 500 of the method according to the embodiments and/or the apparatus 301, 400 according to the embodiments and/or the hardware security module 100, 100′, 100″ according to the embodiments and/or the computing device 300, 1000, 1000′ according to the embodiments and/or the computer-readable storage medium SM according to the embodiments and/or the computer program PRG according to the embodiments and/or the data carrier signal DCS according to the embodiments for at least one of the following elements: a) determining 501 first information I-1, which characterizes an identity of at least one partition of a computing device that is designed to access the hardware security module, for example accesses the hardware security module, b) virtualizing 502 a hardware security module, c) determining 503 an identity of a partition that accesses the hardware security module, d) prioritizing 504 operations associated with different partitions of a computing device on the basis of an identity of at least one of the different partitions, e) increasing 505 a security of a hardware security module that can be accessed by multiple partitions of a computing device.

The principle according to the embodiments can be used, for example, for microprocessors and/or microcontrollers or for SoCs 1000, 1000′, 1000″, for example for control units, for example for vehicles, for example motor vehicles (e.g., control units for internal combustion engines and/or airbags and/or braking systems, etc.), and/or for domain control units, but is not limited thereto.

1-20. (canceled)

21. A method for processing data associated with a hardware security module, the method comprising the following steps:
determining first information, which characterizes an identity of at least one partition of a computing device that accesses the hardware security module; and
using the first information for controlling an operation of the hardware security module based on at least the first information.

22. The method according to claim 21, wherein the determining of the first information includes at least one of the following elements: a) determining the first information based on a communication channel hat is associated with the at least one partition, b) receiving the first information via a communication channel hat is at least temporarily usable by the at least one partition, wherein the communication channel is usable by multiple partitions in time-division multiplexing.

23. The method according to claim 21, further comprising:
receiving, from the at least one partition, second information: (i) including an interrupt request and/or (ii) associated with an interrupt request, from the at least one partition;
determining the first information based on a communication channel via which the second information was received.

24. The method according to claim 21, further comprising at least one of the following elements: a) using a plurality of communication channels for communication with different partitions of the computing device, b) using a common communication channel for communication with different partitions of the computing device based of a time-division multiplexing method.

25. The method according to claim 21, further comprising, for communication with different partitions of the computing device, at least one of the following elements: a) using a first memory area to implement a first communication channel, b) using a second memory area to implement a second communication channel, c) using a third memory area to implement a common communication channel.

26. The method according to claim 21, further comprising at least one of the following elements: a) using a shared memory area to exchange information with the at least one partition, b) virtualizing the shared memory area including allocating different sub-areas to, in each case, a different partition of the computing device, c) using a memory protection unit to protect at least some memory areas from access by at least some partitions of the computing unit.

27. The method according to claim 21, further comprising:
configuring a memory protection unit, the configuring being carried out such that the memory protection unit protects at least one memory area, which is associated with a first partition, from manipulation by at least one other partition.

28. The method according to claim 21, further comprising:
allocating a priority to the at least one partition;
executing an operation associated with the at least one partition, based on at least the priority of the at least one partition.

29. An apparatus for processing data associated with a hardware security module, the apparatus configured to:
determine first information, which characterizes an identity of at least one partition of a computing device that accesses the hardware security module; and
use the first information for controlling an operation of the hardware security module based on at least the first information.

30. The apparatus according to claim 29, wherein a hardware security module comprises the apparatus.

31. The apparatus according to claim 29, wherein a system on a chip (SoC) comprises at least one of: a) the apparatus, b) the hardware security module, c) at least one partition.

32. A method for transmitting data associated with a hardware security module, the method comprising the following steps:
providing an identity for at least one partition of a computing device that is configured to access the hardware security module; and
transmitting information characterizing the identity to the hardware security module, via a communication channel.

33. The method according to claim 12, wherein the providing and/or the transmitting is carried out entirely in a hardware-based manner.

34. A method for transmitting data associated with a hardware security module, comprising the following steps:
providing a first communication channel for exchanging information between a first partition of a computing device and the hardware security module; and
using the first communication channel for exchanging information between the first partition of the computing device and the hardware security module.

35. The method according to claim 34, further comprising:
providing a second communication channel for exchanging information between a second partition of the computing device and the hardware security module; and
using the second communication channel for exchanging information between the second partition of the computing device and the hardware security module.

36. An apparatus configured to transmit data associated with a hardware security module, the apparatus configured to:
provide an identity for at least one partition of a computing device that is configured to access the hardware security module; and
transmit information characterizing the identity to the hardware security module, via a communication channel.

37. A non-transitory computer-readable storage medium on which are stored commands for processing data associated with a hardware security module, the commands, when executed by a computer, causing the computer to perform the following steps:
determining first information, which characterizes an identity of at least one partition of a computing device that accesses the hardware security module; and
using the first information for controlling an operation of the hardware security module based on at least the first information.

38. The method according to claim 21, wherein the method is used for at least one of the following elements: a) determining the first information, which characterizes the identity of the at least one partition of the computing device that is configured access the hardware security module, b) virtualizing the hardware security module, c) determining an identity of a partition that accesses the hardware security module, d) prioritizing operations associated with different partitions of the computing device based on an identity of at least one of the different partitions, e) increasing a security of the hardware security module that can be accessed by multiple partitions of the computing device.
